(19) United States
(12) Patent Application Publication
(10) Pub. No.: US 2008/0291044 A1
(43) Pub. Date: Nov. 27, 2008

(54) Alerting system and process for objects within a detectable range of distance

(76) Inventor: Wan Shan Chan, Monterey Park, CA (US)

Correspondence Address: DAVID AND RAYMOND PATENT FIRM, 108 N. YNEZ AVE., SUITE 128, MONTEREY PARK, CA, 91754, US

(21) Appl. No.: 11/805,618

(22) Filed: May 23, 2007

(51) Int. Cl. G08B 21/00

(52) U.S. Cl. 340/686.6

(57) ABSTRACT

An alerting system for one or more objects belonging to a user having an alert informer, which is adapted for being carried by the user, having an alert generator for generating an alert signal. The alerting system further has one or more target detectors, which are adapted for being held at the objects respectively. The target detectors are wirelessly linked to the alert informer within a detectable range. When one of the target detectors is located out of the detectable range, the alert generator of the alert informer generates the alert signal for informing the user to be aware of the respective object.

### BACKGROUND OF THE PRESENT INVENTION

1. Field of Invention

The present invention relates to an alerting system and process, and more particularly to an alerting system and process for objects within a detectable range of distance such that a user will be alerted when an object leaves a certain distance away from the user.

2. Description of Related Arts

A disadvantage of a conventional alarm such as a car is that it requires installation on an object which is desired to be guarded. The installation process is inconvenient and it requires a battery power source. Using a car alarm for example, the thieves can always disconnect the alarm system from its power source to disarm the system. In other words, such conventional alarm is very dependent on the power source. In addition, such conventional alarm requires relatively high installation cost and professional technicians for installation.

When the conventional alarm triggers, it often produce a very loud noticeable noise to the surrounding of the object. A major disadvantage of such a conventional alarm is that when the alarm is triggered, it does not alert the user.

Majority of the conventional alarms are used against one single object. Users might have multiple objects that are desired to be guarded and in this situation, users might require separate alarm units.

Lastly, conventional alarms system are triggered when they objects are being broken into or stolen (for example, a vehicle). These conventional alarms do not provide any information regarding the distance and range between the objects and the user.

### SUMMARY OF THE PRESENT INVENTION

The main object of the present invention is to provide an alerting system for one or more objects belonging to a user with installation free manner.

Another object of the present invention is to provide an alerting system which alerts the user when the one or more objects are out of the detectable range or when the wireless signals are disconnected between them.

Another object of the present invention is to provide an alerting system which allows the user to immediately identify which object when it is out or the detectable range or when the wireless signals are disconnected between.

Another object of the present invention is to provide an alerting system which allows the user to manually and remotely turn on or turn off the alarm on the guarded objects.

Another object of the present invention is to provide an alerting system which allows the user to manually configure a detectable range on one or more objects.

Another object of the present invention is to provide an alerting system which allows the user to be alerted for one or more objects belonging to him/her without a single alarm/alert system.

Accordingly, in order to accomplish the above objects, the present invention provides an alerting system for one or more objects belonging to a user, comprising:

An alert informer, which is adapted for being carried by the user, comprising an alert generator for generating an alert signal; and

one or more target detectors, which are adapted for being held at the objects respectively, which is wirelessly linked to the alert informer within a detectable range, wherein when one of the target detectors is located out of the detectable range, the alert generator of the alert informer generates the alert signal for informing the user to be aware of the respective object.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an alerting system according to a preferred embodiment of the present invention, illustrating the alert informer wirelessly communicating with one or more target detectors.

FIG. 2 is a perspective view of the alerting system according to the above preferred embodiment of the present invention.

FIGS. 3A through 3C illustrate the setting on the alert informers with respect to target A (car), target B (child), and target C (laptop computer) respectively.

FIG. 4 is a flow chart illustrating a process of providing an alert system for the user to be aware of one or more objects.

FIG. 5 illustrates the target detector being integrated with a laptop computer.

FIG. 6 is a circuit diagram of the target detector of the alerting system according to the above preferred embodiment of the present invention.

FIG. 7 is a circuit diagram of the alert informer of the alerting system according to the above preferred embodiment of the present invention.

### DETAILED DESCRIPTION OF THE PREFERRED EMBODIMENT

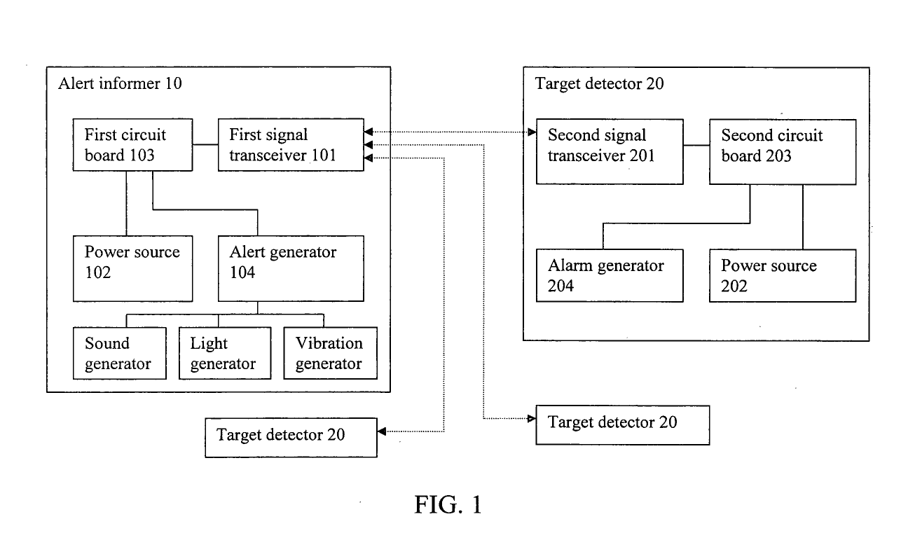

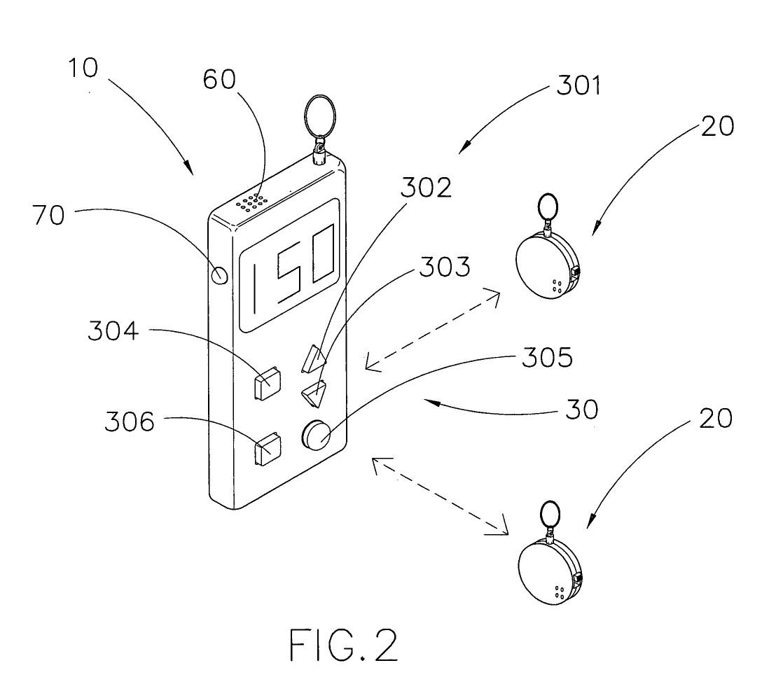

Referring to FIGS. 1 and 2 of the drawings, an alerting system for one or more objects belonging to a user comprises an alert informer 10 adapted for being carried by the user and one or more target detectors 20 adapted for being held at the objects.

The alert informer 10 is handy and small in size which allows user to conveniently carry around. The alert informer 10 further comprises a first signal transceiver 101, a first circuit board 103, an alert generator 104, and a power source 102 build inside the alert informer 10.

The power source 102 could be supported by batteries, such as rechargeable batteries or replaceable batteries, such that no wire connections are required. The power source 102 is electrically connected to the first circuit board 103, the first signal transceiver 101, and the alert generator 104 to provide an electrical power source. The first circuit board 103 sends electrical signals to control the first signal transceiver 101 and the alert generator 104.

The target detector 20 comprises a second signal transceiver 201, a second circuit board 203, an alarm generator 204, and a power source 202 which is electrically connected to the second signal transceiver 201, the second circuit board 203, and then alarm generator 204 for providing an electrical power source for them to function properly in a similar manner as mention above.

The alert informer 10 and the target detector 20 are linked wirelessly by a wireless signal communication between the first signal transceiver 101 and the second signal transceiver 201. Such wireless signal communication can be performed by use of any type of wireless technologies nowadays such as radio frequency, infrared, or WIFI.

FIG. 2 of the drawings illustrates a perspective view of the preferred embodiment of the present invention. The alert informer 10 as shown in the figure further comprises a control panel 30 for manually controlling the first signal transceiver 101 to wirelessly active the second signal transceiver 201 in an on and off manner. In addition, the control panel 30 is adapted to manually activate the alert generator 104 and the alarm generator 204 of the target detector 20 in an on and off manner.

The control panel 30 further comprises a range setter 301 which is connected electronically to communicate with the control panel 30 with a range signal and is adapted for manually and adjustably setting a detectable range from the alert informer 10 to each of the target detectors 20 within a predetermined maximum detecting range.

The range setter 301 further comprises range setting buttons 302, 303 allowing the user to manually adjust the detectable range. The control panel 30 further comprises a display monitor 304 which is adapted to display the range signal from the range setter 301 such that the user can conveniently monitor the detectable range of the respective object. A wireless signal is constantly communicating between the first transceiver 101 of the alert informer 10 and all of the second transceivers 201 of the target detectors 20. The wireless signal received by the first transceiver 101 of the alert informer 10 allows the alert informer 10 to determine a range distance between the alert informer 10 and all of the target detectors 20.

The range distances between each of the target detectors 20 and the alert informer 10 could then be displayed on the display monitor 304 of the control panel 30 such that the user can find out the range distance of each of the target detectors 20 with respect to a position of the alert informer 10. The control panel 30 further comprises a target selecting button 306 which allows the user to conveniently select the object to be adjusted and to display the range distance of each of the target detectors and to view the current detectable range while adjusting with the range setting buttons 302, 303.

When the wireless signal received by the first transceiver 101 shows that one of the target detectors 20 is out of the detectable range, the alert generator 104 of the alert informer 10 is triggered immediately to produce an alert noise through a speaker 60 of the alert informer 10 to notify the user. According to FIG. 1 of the drawings, the alert generator 104 of the alert informer 10 is preferably a sound signal though the speaker. Alternatively, the alert generator 104 could also produce an illumination signal through a lighting device 70, such as a LED, of the alert informer 10. The alert generator 104 can also produce a vibration signal to notify the user through vibration device. The alert generator 104 can also be wirelessly linked to another alerting station such a police station or security department to send a notifying signal to alert. The alert generator 104 could use a combination of the above mention methods for alerting the user regarding one or more objects. The control panel further comprises an alert generating selector 306 for selecting different alerting method as mentioned above.

In addition of alerting the user when the target detector is out of range, the alarm generator 204 of the target detector 20 is triggered immediately and produces a loud alarm noise to the surrounding for warning to suggest that the object is belonged to the user. The control panel 30 of the alert informer 10 further comprises a target alarm trigger 305 which is adapted for user to manually activate the alarm generator 204 of the target detector 20 in an on and off manner.

In addition, the alert generator 104 and the alarm generator 204 will also be triggered whenever the second signal transceiver 201 is wirelessly disconnected to the first transceiver 101. The power source 202 of the target detector 20 could be disabled by a thief and the second signal transceiver 201 would fail to communicate with the first signal transceiver 101 regardless of the second signal transceiver 201 to be within the detectable range or not. In this situation, the alert generator 104 of the alert informer 10 will be triggered to notify the user to be aware.

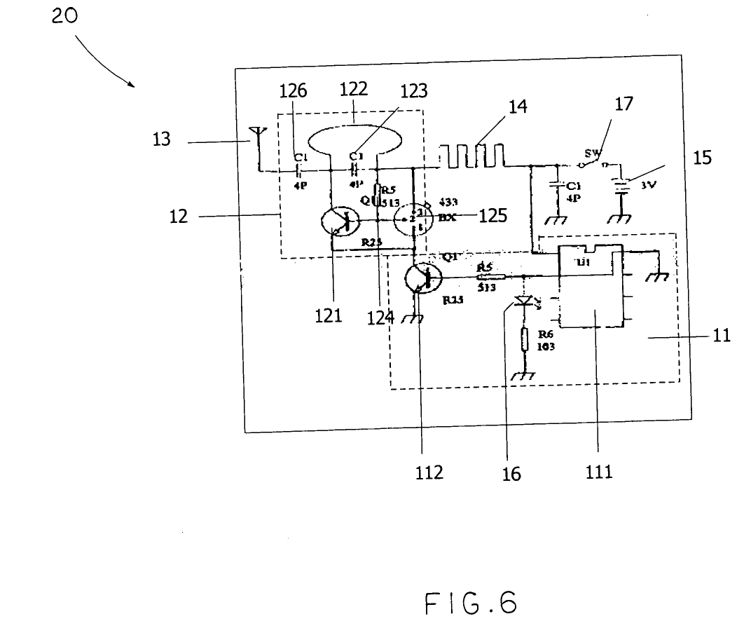

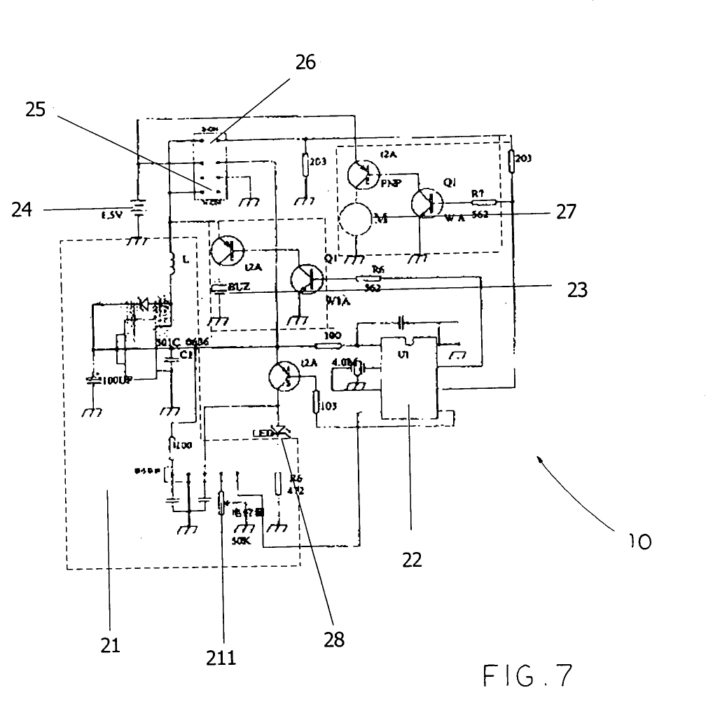

As shown in FIGS. 6 and 7, the circuit diagrams of the target detector 20 and the alert informer 10 of the alerting system according to the above preferred embodiment of the present invention are illustrated respectively.

As shown in FIG. 6, the target detector 20 comprises an MCU module 11, an oscillator 12 connected with the MCU module 11, an antenna 13 connected with the oscillator, a filter 14 connected with the oscillator 12, and a power supply 15 connecting to the MCU module 11 and the filter 14 respectively for supplying power to the oscillator 12 and MCU module 11.

As shown in FIG. 7, the alert informer 10 comprises a receiving module 21, a MCU 22 connected with the receiving module 21, a BUZ module 23 connected with the MCU, a power supply 24 for supplying power to the receiving module 21, the MCU 22, and the BUZ module 23.

The MCU module 11 produces a 1 second pulse signal and input the signal into the oscillator 12, the oscillator produces a high-frequency signal and sends the signal into the antenna 13, and then the antenna 13 transmits the signal out into the air. The power supply 15 supplies the power to the oscillator 12 through a filter 14, wherein the filter 14 conducts DC current from the power supply 15 to the oscillator 12 and obstructs high-frequency signal from the oscillator 12 to the power supply 15 and the clutters from the MCU to the oscillator 12. The power supply 15 supplies the power to the MCU module 11 at the same time. Therefore, the target detector 20 can transmit a constant high-frequency signal.

The receiving module 21 wirelessly receives the signal transmitted by the antenna 13 of the target detector 20, and sends the signal into the MCU 22. To receive the big enough signal transmitted by the antenna 13 of the target detector 20, the target detector 20 must be operating, and within a certain distance from the alert informer 10, because the signal will attenuate for transmitting over a certain distance. For example, if the target detector 20 is far away from the alert informer 10, the signal transmitted from the target detector 20 may attenuating to much, so that the alert informer 10 can not receive big enough signal; on the contrary, when the target detector 20 is within a certain distance range, the alert informer 10 can receive big enough signal from the target detector 20. The MCU 22 judges the voltage of the received signal. If the voltage of the received signal is higher than a predetermined value, the MCU 22 assumes that the target detector 20 is in a safe distance range; if the voltage of the received signal is lower than a predetermined value, or is not operating, such as power off, the MCU 22 assumes that the target detector 20 is out of the safe distance range, and then the MCU 22 will controls the BUZ module 23 to make sounds for altering the user that the protected object with the target detector 20 is out of the safe distance range.

The MCU module 11 comprises a MCU 111 and a transmitter driver 112 connected with the MCU 111 and the oscillator 12, wherein the MCU 111 produces a 1 second pulse signal and the pulse signal is excited by the transmitter driver 112 and is input into the oscillator 12. The filter 14 may be embodied as an inductance to let the DC passing through and obstruct the high-frequency signals and clutters. The target detector 20 further comprises a LED 16 connected between the MCU 111 and the transmitter driver 112 for indicating whether the target detector 20 is operating or not. And the target detector 20 further comprises switch 17 connected with the power supply 15 for turning on or off the power supply 15.

The oscillator 12 comprises an oscillating transistor 121, an oscillating inductance 122, an oscillating capacitor 123 parallel with the oscillating inductance 122, a capacitor 126 connected with the antenna 13, a resistor 124 as a base bias connected with the base of the oscillating transistor 121, and a SAWF 125 (Surface Acoustic Wave Filter). The SAWF 125 determines the frequency of the oscillator 13, which is an international spare frequency. If the parameter of the SAWF 125 is changed, the transmitting frequency of the target detector 20 is changed too. Therefore, the wireless alerting system may comprise a plurality of target detectors 20, which have different transmitting frequencies, to communicate with the alert informer 10 respectively.

The receiving module 21 comprises a potentiometer 211 for adjusting the voltage of the receiving signal. Therefore, the safe distance range between the target detector 20 and the alert informer 10 can be adjusted. For example, when the potentiometer 211 raises the voltage of the receiving signal, the safe distance between the target detector 20 and the alert informer 10 can be enlarged; on the contrary, when the potentiometer 211 lowers the voltage of the receiving signal, the safe distance between the target detector 20 and the alert informer 10 is reduced.

The alert informer 10 further comprises a motor 27 connected with the MCU 22, and further comprises two switches: searching switch 25, and alerting switch 26 connected to the power supply 24 respectively, wherein the motor 27 is connected with the searching switch 25, and the alerting switch 26 is connected with the BUZ module. The alert informer 10 further comprises a LED 28 connected with the alert informer 10 and the power supply to indicate that the alert informer 10 is operating.

When the alerting switch 26 is switched on, the MCU 22 of the alert informer 10 will control the BUZ module to sound, if the receiving module can not receive a signal higher than predetermined value. When the searching switch 25 is switched on, if the receiving module can not receive a signal lower than predetermined value, the MCU 22 of the alert informer 10 will control the motor 27 to shake; if the receiving module can not receive a signal higher than predetermined value, the MCU 22 of the alert informer 10 will control the motor 27 stopping to shake, and control the BUZ module 23 to sound.

Therefore, when the user needs to protect the object within a certain range around, he or she is able to place the target detector 20 at the object as it is mentioned above, and is able to switch on the alerting switch 26. If the object is out of a predetermined distance range, the BUZ module 23 of the alert informer 10 will sound to alert the user. When the user wants to find seek for target detector 20, he or she is able to switch on the searching switch 25, the motor 27 will be automatically actuated. When the user with alert informer 10 get close to the object with target detector 20, the BUZ module 23 of the alert informer 10 will sound to tell the user that the target is very near.

The receiving module 21 further comprises a voltage boost regulator 212 connected with the power supply to raise the voltage of the power supply to the receiving module 21.

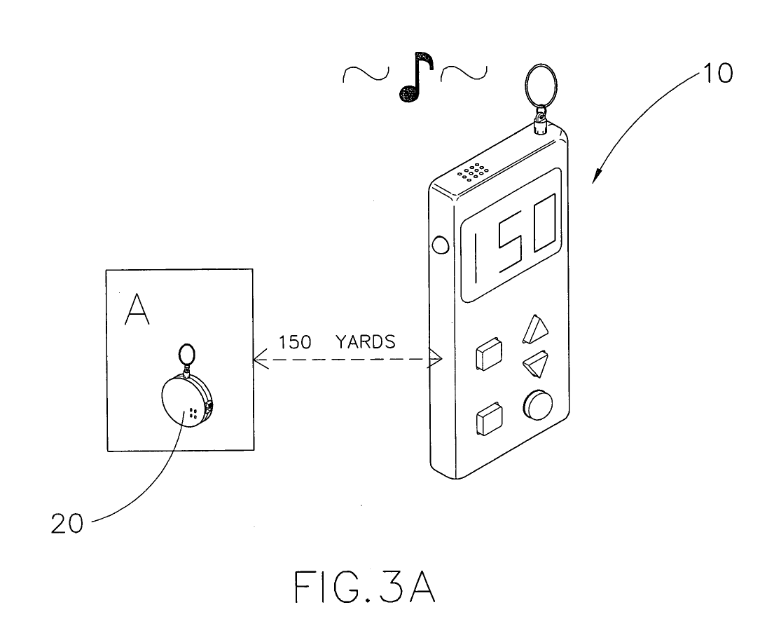

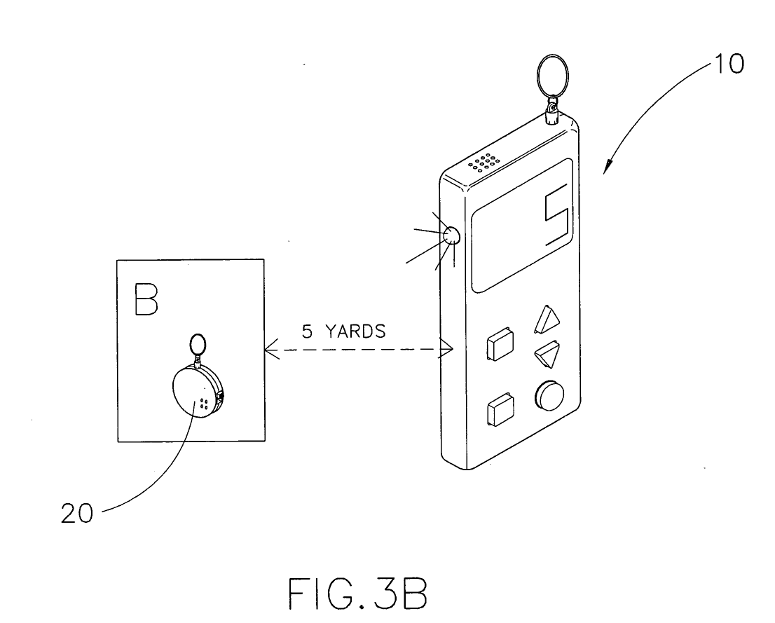

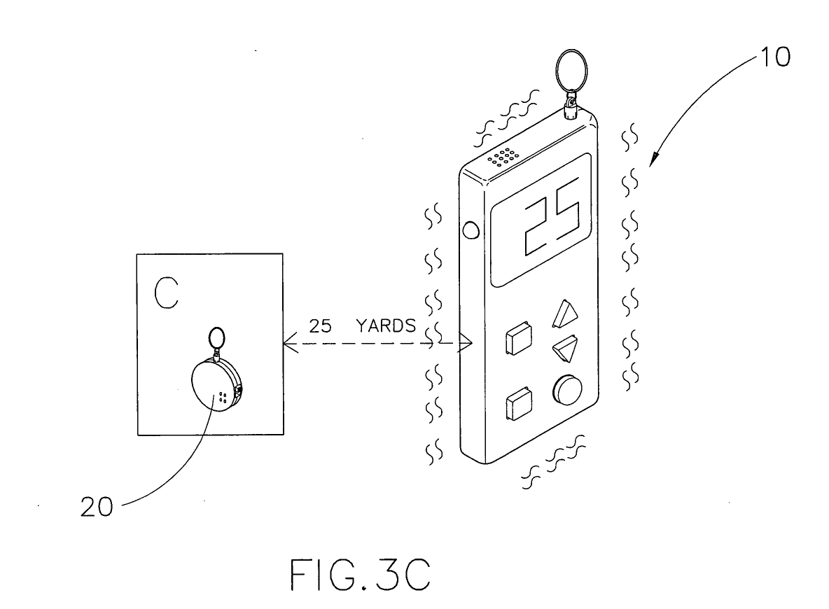

FIGS. 3A to 3C illustrate the examples of how the present invention could be used for detecting multiple objects. The user wants to be aware of three objects when he goes to a restaurant for lunch. The three objects that he wants to be aware of are his car, his child, and his laptop computer represented by A, B, C respectively. The user carries the alert informer 10 with him, and he attaches the target detectors 20 on his car, laptop computer, and child respectively. The user parks his car in the restaurant parking lot and takes his laptop computer and child into the restaurant for lunch. The restaurant parking lot is approximately 100 yards from the restaurant so the users uses the target selecting button 304 to select the target detector 20 on the car and he adjusts the detectable range to be 150 yards as shown in FIG. 3A. The alert generator 104 is set to produce the alert noise though the speaker by the alert generating selector 306.

The user then goes into the restaurant and settles down to order lunch for himself and his child. The user then decides to check his work email from his computer laptop. While concentrating on replying his work email, he is afraid that his child will run far away and get in trouble. The user then attaches another target detector 20 on his child. He uses the target selecting button 304 to select the target detector 20 on his child and adjusts the detectable range to be 5 yards. In addition, the user sets the alert generator 104 to produce the illumination signal through the lighting device of the alert informer 10 with respect to the target detector 20 on the child such that the user can conveniently identify the respective object when the alert generator 104 is triggered. The user then continues to concentrate on replying his work email and lets the child goes play. After 5 minutes, the alert generator 104 of the alert informer 10 is triggered and produces the illumination signal as shown in FIG. 3B of the drawings. Immediately, the alarm generator 204 of the target detector 20 on the child is triggered and produces an alarm noise to warn the child not to go beyond the 5 yards range. The user was notified by the illumination signal and he gets up from the table and immediately uses the target alarm trigger 305 to disable the alarm noise from the target detector 20 on the child. The child then comes back to the lunch table safely.

While the user is replying the work email, the child needs to go to restroom and requires the escort of the user. The restroom is approximately 20 yards away from a current position of the user and it is very inconvenient to carry the computer laptop to the bathroom. The user then attaches another target detector 20 on the computer laptop and he sets the detectable range to be 25 yards. In order to conveniently identify each of the respective objects, the user sets the alert generator 104 to produce the vibration signal if the computer laptop goes out of the 25 yards detectable range. The user then leaves the computer laptop on the lunch table and escorts the child to the bathroom. While in the bathroom, the alert generator 104 of the alert informer 10 produces the vibration signal to notify the user as shown in FIG. 3C of the drawings. The user immediately runs back to the lunch table and the computer laptop is missing. He then hears the alarm noise from alarm generator 204 of the target detector 20 and he finds the computer laptop to be near the entrance of the restaurant which is beyond the 55 yards detectable range from the bathroom. After recovering the computer laptop, the user immediately uses the target alarm trigger 305 to disable the alarm noise from the target detector 20 on the computer laptop. The user is then told by a waitress from the restaurant that a thief tried to steal the unattended computer laptop while the user was in the bathroom. But when the thief went beyond the 55 yards detectable range near the entrance of the restaurant, the alarm generator was triggered and produced the alarm noise. The thief then quickly left the computer laptop behind and fled. It is worth to mention that the alert signal is only deactivated manually via the alert informer 10.

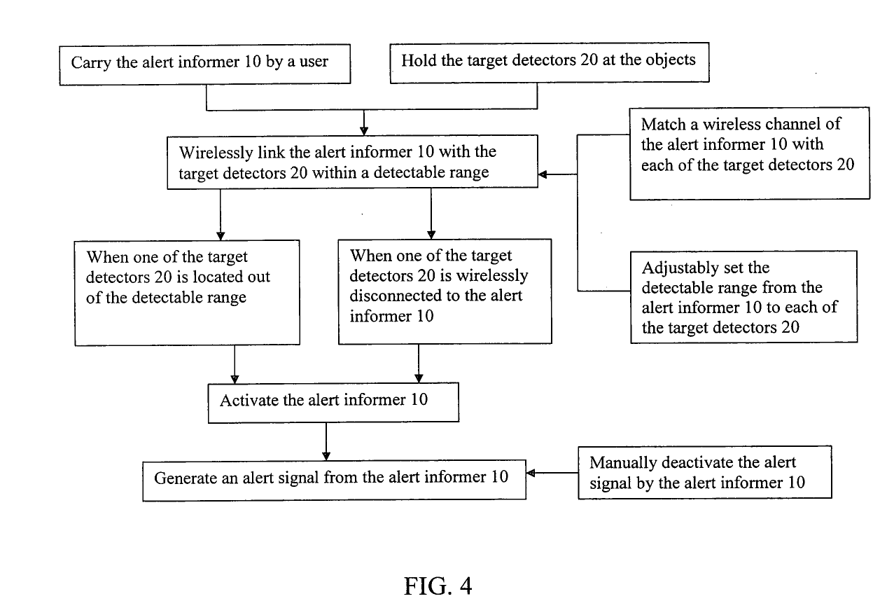

FIG. 4 illustrates a flow chart displaying a process of providing an alert of the user to be aware of one or more objects. The process comprises the steps as follow:

i) The alert informer 10 is carried by the user and one or more target detectors 20 are being held at the target respectively.

ii) The alert informer 10 and the target detectors 20 are wirelessly linked within a detectable range via radio frequency

iii) Each of the target detectors 20 matches a wireless channel with the alert informer 10 such that each of the target detectors 20 and the alert informer 10 are linked wirelessly with a predetermined wireless channel.

iv) Adjustably setting the detectable range from the alert informer 10 to each of the target detectors 20 such that each of the target detectors 20 is wirelessly linked to the alert informer 10 with a predetermined range of distance.

v) Generating an alert signal from the alert informer 10 and an alarm signal from the respective target detector 20 in condition that:

1) when one of the target detectors 20 is located out of the detectable range;

2) when one of the target detectors 20 is wirelessly disconnected to the alert informer 10. In other words, when the target detector 20 is out of battery or is out of the maximum range, the alert informer 10 will be automatically activated.

vi) Both the alert and alarm signals can be deactivated by the alert informer 10.

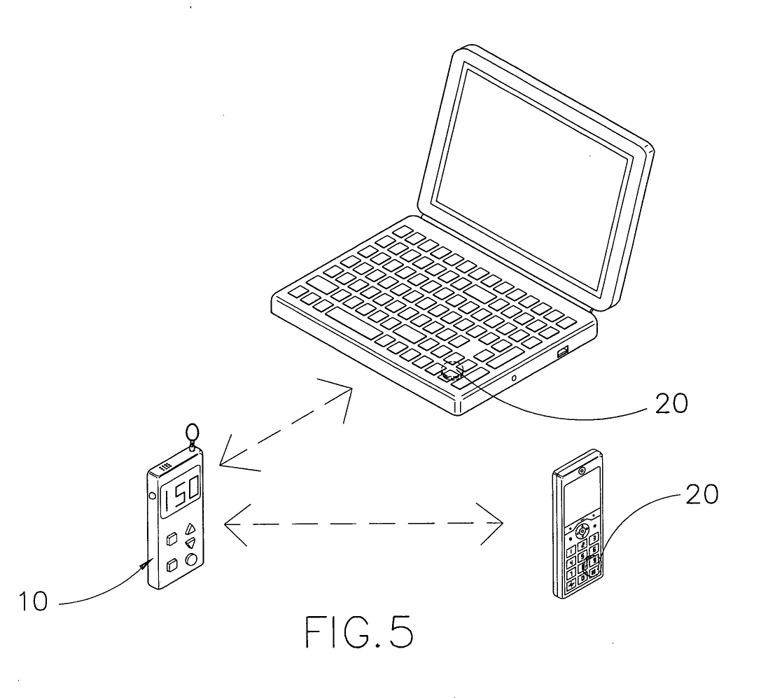

As shown in FIG. 2 of the drawings, the alert informer 10 can be attached to a key chain 40 of the user or directly taken by the user such that the alert informer 10 can be conveniently be carried by the user. Accordingly, the target detectors 20 can be attached to any kinds of personal belongings by any conventional attachment configuration. For example, the target detector 20 is carried by the child. The target detector 20 can also integrated with the computer laptop or cellular phone as shown in FIG. 5 of the drawings.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An alerting system for one or more objects belonging to a user, comprising:
an alert informer, which is adapted for being carried by the user, comprising an alert generator for generating an alert signal; and
one or more target detectors, which are adapted for being held at the objects respectively, which is wirelessly linked to said alert informer within a detectable range, wherein when one of said target detectors is located out of said detectable range, said alert generator of said alert informer generates said alert signal for informing the user to be aware of the respective object.

2. The alerting system, as recited in claim 1, wherein said alert informer further comprises a first signal transceiver, wherein each of said target detectors further comprises a second signal transceiver which is wirelessly linked to said first signal transceiver and is arranged in such a manner that when said first signal transceiver detects said second signal transceiver being out of said detectable range, said alert generator is automatically activated to generate said alert signal.

3. The alerting system, as recited in claim 2, wherein said alert generator is automatically activated to generate said alert signal when said second signal transceiver is wirelessly disconnected to said first signal transceiver.

4. The alerting system, as recited in claim 2, wherein said alert informer further comprises a control panel not only manually controlling said first signal transceiver to wirelessly activate said second signal transceiver in an on and off manner but also manually activating said alert generator in an on and off manner.

5. The alerting system, as recited in claim 3, wherein said alert informer further comprises a control panel not only manually controlling said first signal transceiver to wirelessly activate said second signal transceiver in an on and off manner but also manually activating said alert generator in an on and off manner.

6. The alerting system, as recited in claim 1, wherein said alert informer further comprises a range setter manually and adjustably setting said detectable range from said alert informer to each of said target detectors.

7. The alerting system, as recited in claim 3, wherein said alert informer further comprises a range setter manually and adjustably setting said detectable range from said alert informer to each of said target detectors.

8. The alerting system, as recited in claim 5, wherein said alert informer further comprises a range setter manually and adjustably setting said detectable range from said alert informer to each of said target detectors.

9. The alerting system, as recited in claim 1, wherein each of said target detectors further comprises an alarm generator generating an alarm signal when said respective target detector is located out of said detectable range.

10. The alerting system, as recited in claim 5, wherein each of said target detectors further comprises an alarm generator generating an alarm signal when said respective target detector is located out of said detectable range.

11. The alerting system, as recited in claim 8, wherein each of said target detectors further comprises an alarm generator generating an alarm signal when said respective target detector is located out of said detectable range.

12. A process of providing an alert of the user to be aware of one or more objects, comprising the steps of:
(a) providing an alert informer being carried by a user and one or more target detectors being held at the objects respectively;
(b) wirelessly linking said alert informer with said target detectors within a detectable range; and
(c) generating an alert signal from said alert informer when one of said target detectors is located out of said detectable range for informing the user to be aware of the respective object.

13. The process, as recited in claim 12, wherein the step (b) further comprising the steps of:
(b.1) matching a wireless channel of said alert informer with each of said target detectors such that each of said target detectors is wirelessly linked to said alert informer at a predetermined wireless channel; and
(b.2) adjustably setting said detectable range from said alert informer to each of said target detectors such that each of said target detectors is wirelessly linked to said alert informer with a predetermined range of distance.

14. The process, as recited in claim 13, wherein, in the step (c), said alert signal is generated in condition that:
(i) when one of said target detectors is located out of said detectable range; and
(ii) when one of said target detectors is wirelessly disconnected to said alert informer.

15. The process, as recited in claim 12, further comprising a step of automatically generating an alarm signal from said respective target detector when said target detector is located out of said detectable range.

16. The process, as recited in claim 14, further comprising a step of automatically generating an alarm signal from said respective target detector when said target detector is located out of said detectable range.

17. The process, as recited in claim 12, wherein said alert signal is only deactivated manually via said alert informer.

18. The process, as recited in claim 16, wherein said alert signal is only deactivated manually via said alert informer.

19. The process, as recited in claim 12, wherein said alert informer is wirelessly linked to said target detectors via radio frequency.

20. The process, as recited in claim 18, wherein said alert informer is wirelessly linked to said target detectors via radio frequency.
